(19) United States
(12) Patent Application Publication
(10) Pub. No.: US 2025/0324939 A1
(43) Pub. Date: Oct. 23, 2025

(54) ANIMAL ENCLOSURE LID

(71) Applicant: ClearH2O, Inc., Portland, ME (US)

(72) Inventors: Jay Palmer, Brunswick, ME (US); Paul Dioli, Yarmouth, ME (US)

(21) Appl. No.: 19/186,741

(22) Filed: Apr. 23, 2025

Related U.S. Application Data
(60) Provisional application No. 63/637,444, filed on Apr. 23, 2024.

(51) Int. Cl. A01K 1/03; A01K 7/00

(52) U.S. Cl. CPC A01K 1/03; A01K 7/00

(57) ABSTRACT

An improved lid for a small animal enclosure is disclosed. To supply liquid to an interior of the animal enclosure, the disclosed lid may include a receptacle feature configured to accommodate, in a first instance, a bottle and, in a second instance, a soft-bodied container. The disclosed lid also may include one or more bottle retention features configured to facilitate retention of a bottle within the receptacle feature. The disclosed lid further may include a ramp feature adjoining the receptacle feature such that a bottom of the ramp feature transitions to an interior of the receptacle feature. The ramp feature may be configured to have at least a portion of a soft-bodied container laid thereon and to direct (e.g., funnel) liquid contents thereof to the receptacle feature.

### CROSS-REFERENCE TO RELATED APPLICATIONS

This patent application claims the benefit of U.S. Provisional Patent Application No. 63/637,444, titled “Animal Enclosure Lid,” filed on Apr. 23, 2024, which is herein incorporated by reference in its entirety.

### FIELD OF THE DISCLOSURE

The present disclosure relates to animal enclosures and, more particularly, lids for animal enclosures.

### BACKGROUND

Small animal enclosures are routinely used to house, at least on a temporary basis, small animals, such as mice and other rodents. Some such enclosures are constructed with a main body that provides a cage or other suitable volume to be occupied by the housed animal(s) and a corresponding lid that interfaces with an open side or end of the main body to prevent escape of the animal(s). In some such instances, the lid is configured to host an inverted bottle for the purpose of dispensing a liquid for consumption by the animal(s) housed in the enclosure.

### SUMMARY

The subject matter of this application may involve, in some cases, interrelated products, alternative solutions to a particular problem, and/or a plurality of different uses of a single system or article.

A first example embodiment provides a lid configured to interface with an animal enclosure. The lid includes a receptacle feature configured to both: receive, in a first instance, a bottle for supplying liquid to an interior of the animal enclosure; and receive, in a second instance, a soft-bodied container for supplying liquid to the interior of the animal enclosure. The lid further includes a ramp feature adjoining the receptacle feature such that a bottom of the ramp feature transitions to an interior of the receptacle feature, wherein the ramp feature is configured to have at least a portion of the soft-bodied container positioned thereon in the second instance.

In some cases, the bottom of the ramp feature is substantially planar in shape. In some other cases, the bottom of the ramp feature is non-planar in shape. In some cases, the bottom of the ramp feature is substantially smooth. In some other cases, the bottom of the ramp feature is textured. In some cases, the lid further includes a layer of a non-slip material disposed over the bottom of the ramp feature.

In some cases, sidewalls of the ramp feature extend substantially parallel to one another along a length of the ramp feature. In some other cases, sidewalls of the ramp feature converge toward one another along a length of the ramp feature. In some cases, the lid further includes a layer of a non-slip material disposed over at least one sidewall of the ramp feature.

In some cases, the ramp feature extends away from the receptacle feature at an angle of about 10° or greater. In some cases, the ramp feature extends away from the receptacle feature at an angle in the range of about 15-45°. In some cases, the ramp feature extends away from the receptacle feature at an angle in the range of about 30°-50°. In some cases, the ramp feature extends away from the receptacle feature at an angle in the range of about 30°±15°. In some cases, the ramp feature extends away from the receptacle feature at an angle in the range of about 45°±5°.

In some cases, a floor of the receptacle feature has at least one orifice formed therein, through which liquid passes in at least one of the first instance and the second instance. In some such instances, the at least one orifice is configured as a weep hole.

In some cases, the lid further includes at least one bottle retention feature configured to facilitate retention of the bottle within the receptacle feature in the first instance. In some such instances, the at least one bottle retention feature is configured to prevent rotation of the bottle within the receptacle feature in the first instance.

In some cases, the lid further includes at least one retaining feature configured to hold the soft-bodied container in position along the ramp feature in the second instance. In some such instances, the at least one retaining feature is configured to interface with an end of the soft-bodied container which is distal to the receptacle feature. In some such instances, in being configured to interface with the end of the soft-bodied container, the at least one retaining feature is configured to clamp the end against a surface of the lid.

A second example embodiment provides a system including the lid of the first example embodiment and a valve configured to be disposed at least in part within at least one orifice formed in a floor of the receptacle feature. In some instances, the valve is configured to penetrate the soft-bodied container to allow liquid to flow therefrom through the valve in the second instance. In some such instances, the system further includes the soft-bodied container.

A third example embodiment provides a system including the lid of the first example embodiment and the bottle.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1 illustrates an isometric view of a lid configured in accordance with an embodiment of the present disclosure.

FIG. 2 illustrates another isometric view of the lid of FIG. 1 in accordance with an embodiment of the present disclosure.

FIG. 3 illustrates a top-down plan view of the lid of FIG. 1 in accordance with an embodiment of the present disclosure.

FIG. 4 illustrates a bottom-up plan view of the lid of FIG. 1 in accordance with an embodiment of the present disclosure.

FIG. 5 illustrates a side elevation view of the lid of FIG. 1 in accordance with an embodiment of the present disclosure.

FIG. 6 illustrates an end elevation view of the lid of FIG. 1 in accordance with an embodiment of the present disclosure.

FIG. 7 illustrates another end elevation view of the lid of FIG. 1 in accordance with an embodiment of the present disclosure.

FIG. 8 illustrates another isometric view of the lid of FIG. 1 hosting a bottle in accordance with an embodiment of the present disclosure.

FIG. 9 illustrates another top-down plan view of the lid of FIG. 1 hosting a bottle in accordance with an embodiment of the present disclosure.

FIG. 10 illustrates a top-down plan view of the lid of FIG. 1 hosting a soft-bodied container in accordance with an embodiment of the present disclosure.

FIG. 11 illustrates a side elevation cross-sectional view of the lid of FIG. 1 hosting a soft-bodied container in accordance with an embodiment of the present disclosure.

FIG. 12 illustrates an isometric view of another lid configured in accordance with an embodiment of the present disclosure.

FIG. 13 illustrates another isometric view of the lid of FIG. 12 in accordance with an embodiment of the present disclosure.

FIG. 14 illustrates a top-down plan view of the lid of FIG. 12 in accordance with an embodiment of the present disclosure.

FIG. 15 illustrates a side elevation view of the lid of FIG. 12 in accordance with an embodiment of the present disclosure.

FIG. 16 illustrates an end elevation view of the lid of FIG. 12 in accordance with an embodiment of the present disclosure.

These and other features of the present embodiments will be understood better by reading the following detailed description, taken together with the figures herein described. In the drawings, each identical or nearly identical component that is illustrated in various figures may be represented by a like numeral. For purposes of clarity, not every component may be labeled in every drawing. Furthermore, as will be appreciated in light of this disclosure, the accompanying drawings are not intended to be drawn to scale or to limit the described embodiments to the specific configurations shown.

### DETAILED DESCRIPTION

An improved lid for a small animal enclosure is disclosed. To supply liquid to an interior of the animal enclosure, the disclosed lid may include a receptacle feature configured to accommodate, in a first instance, a bottle and, in a second instance, a soft-bodied container. The disclosed lid also may include one or more bottle retention features configured to facilitate retention of a bottle within the receptacle feature. The disclosed lid further may include a ramp feature adjoining the receptacle feature such that a bottom of the ramp feature transitions to an interior of the receptacle feature. The ramp feature may be configured to have at least a portion of a soft-bodied container laid thereon and to direct (e.g., funnel) liquid contents thereof to the receptacle feature. Numerous configurations and variations will be apparent in light of this disclosure.

### General Overview

Some existing small animal enclosures are constructed to host an inverted bottle for dispensing liquids for consumption by animal(s) housed in the enclosure. To that end, the lid of the enclosure is formed with a vertical cavity that is intended to physically host the inverted bottle. Typically, the cavity is of a geometry that accommodates bottles of small size and square body profile. However, cavities of this configuration sometimes also are used to accommodate soft-bodied containers like pouches, sacks, bladders, bags, and the like, though they do so poorly. M ore specifically, when inserted within such a cavity, the soft-bodied container extends well beyond the surface of the lid, presenting a knock-over hazard for the enclosure. Moreover, the soft-bodied containers tend to fold or flop over upon themselves under their own weight, trapping their liquid contents and preventing further dispensation thereof. If such a collapsed soft-bodied container is not repositioned or swapped out in a timely manner to restore liquid flow, the housed animal(s) can risk dehydration and death.

Thus, and in accordance with some embodiments of the present disclosure, an improved lid for a small animal enclosure is disclosed. To supply liquid to an interior of the animal enclosure, the disclosed lid may include a receptacle feature configured to accommodate, in a first instance, a bottle and, in a second instance, a soft-bodied container. The disclosed lid also may include one or more bottle retention features configured to facilitate retention of a bottle within the receptacle feature. The disclosed lid further may include a ramp feature adjoining the receptacle feature such that a bottom of the ramp feature transitions to an interior of the receptacle feature. The ramp feature may be configured to have at least a portion of a soft-bodied container laid thereon and to direct (e.g., funnel) liquid contents thereof to the receptacle feature.

In accordance with some embodiments, the disclosed lid may be compatible for use with any of a wide range of both rigid and semi-rigid liquid bottles of a given geometry (e.g., polygonal or closed-curve), as well as soft-bodied liquid containers, such as pouches, sacks, bladders, bags, and the like. For example, in accordance with some embodiments, the disclosed lid may be compatible for use with a ready-to-use liquid pouch, such as an AQUAPAK® pouch available from ClearH₂O, Inc. Additionally (or alternatively), the disclosed lid may have one or more orifices formed therein which are compatible for use with an animal drinking valve, such as an AQUAVALVE® valve available from ClearH₂O, Inc. More generally, the disclosed lid may be compatible for use with a wide range of liquid sources employing valve and/or weep hole flowthrough designs.

Some embodiments of the disclosed lid may realize one or more advantages or benefits as compared to existing approaches. For example, in some embodiments, the disclosed lid may be configured to accommodate soft-bodied liquid containers of greater width and/or length than can be done utilizing existing lid designs. In some embodiments, the disclosed lid may be configured to generate a funneling effect via its one or more ramp features, facilitating reliable liquid flow into the animal enclosure. In at least some cases, the disclosed lid may be made from one or more materials which make it reusable, disposable, or recyclable, as desired in a given circumstance. Furthermore, the disclosed lid may be configured, in accordance with some embodiments, to be compatible for use with both disposable and non-disposable animal enclosures (e.g., cages). Additionally, the disclosed lid may be manufactured via any of a wide range of suitable manufacturing processes, including, for example, thermoforming, vacuum forming, injection molding, compression molding, and three-dimensional (3D) printing, to name a few.

### Structure and Operation

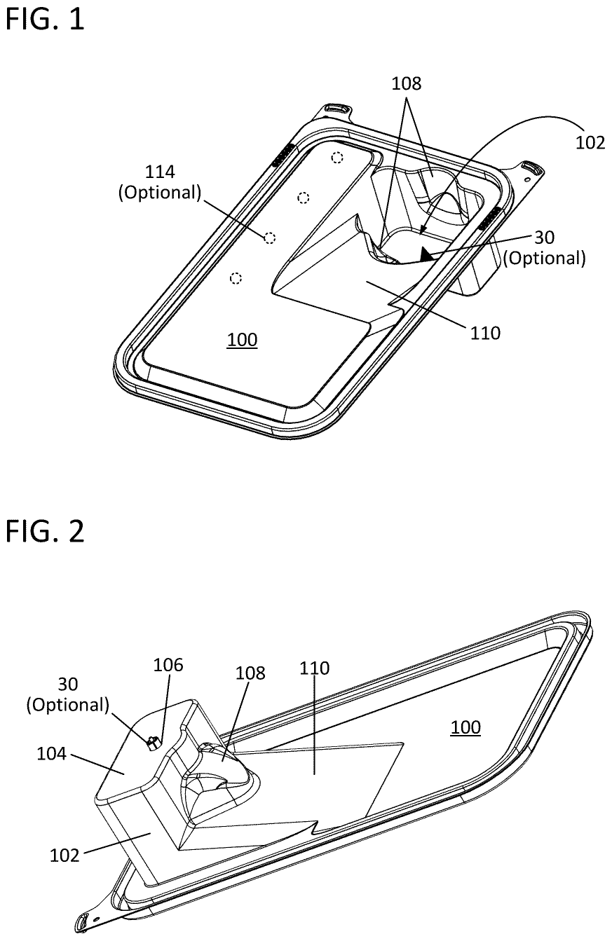

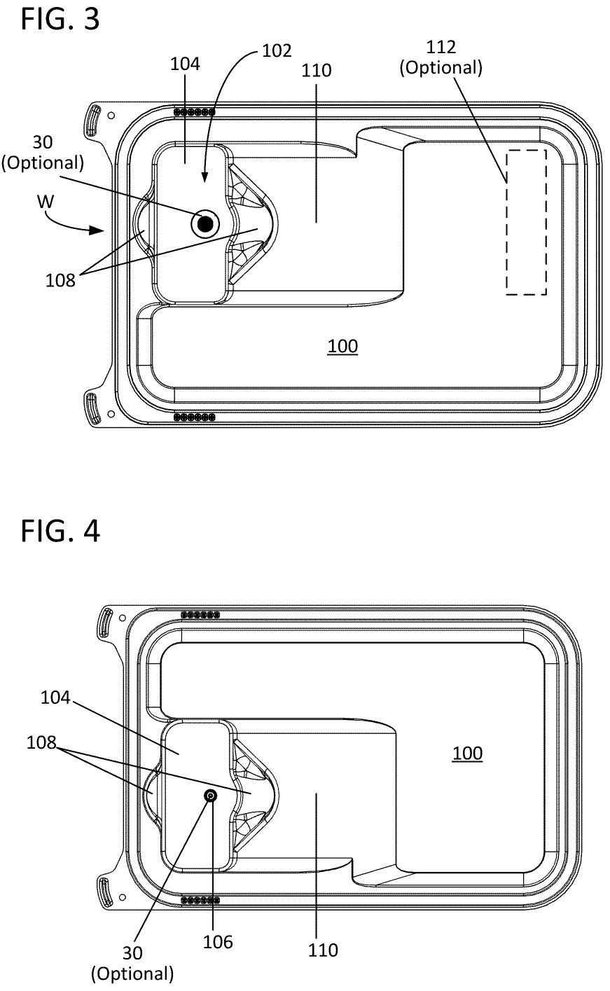

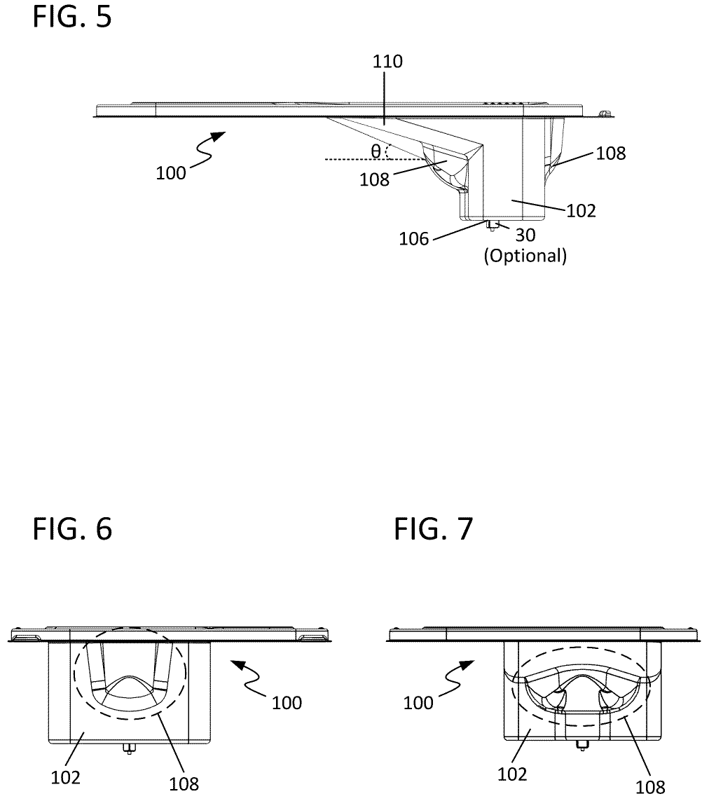

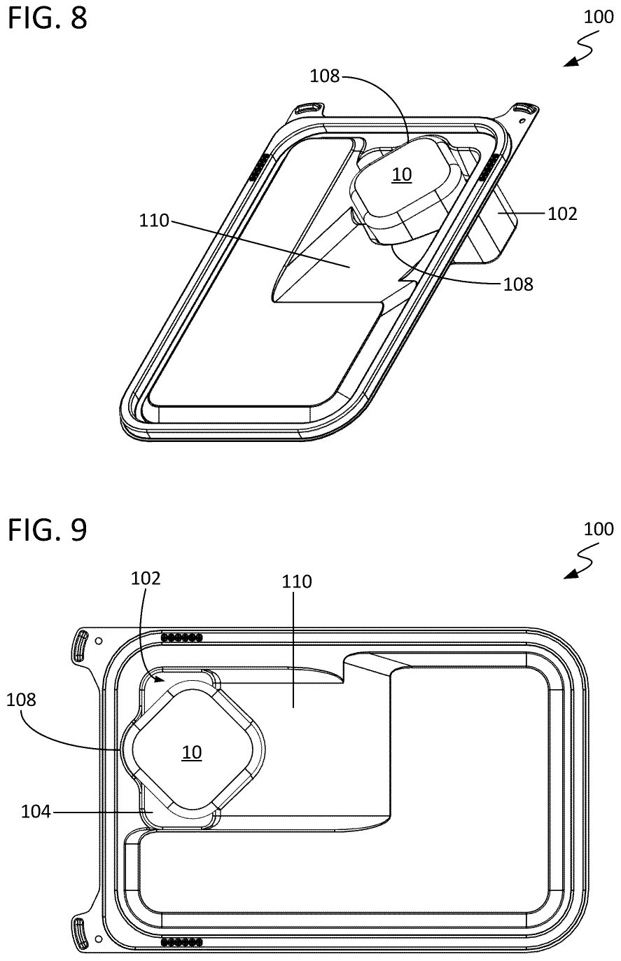

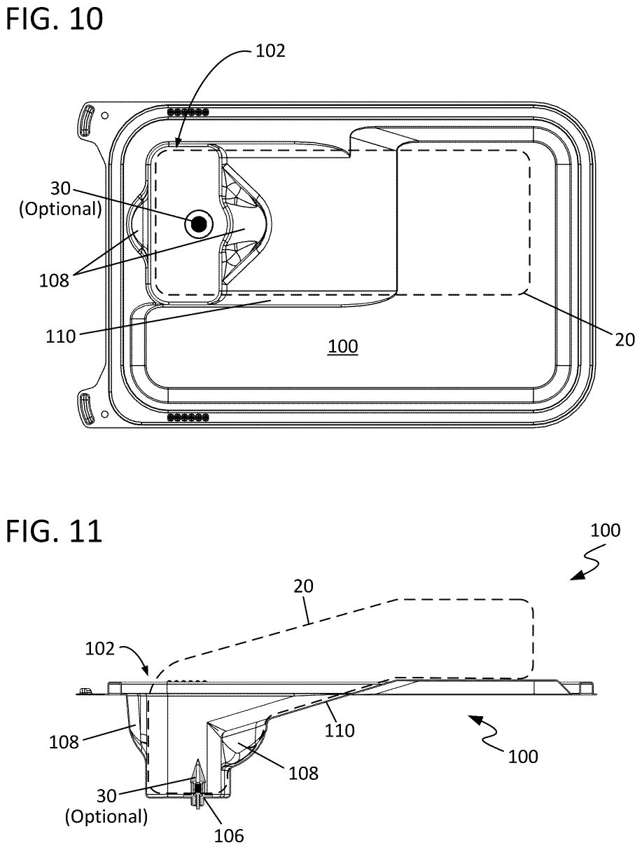

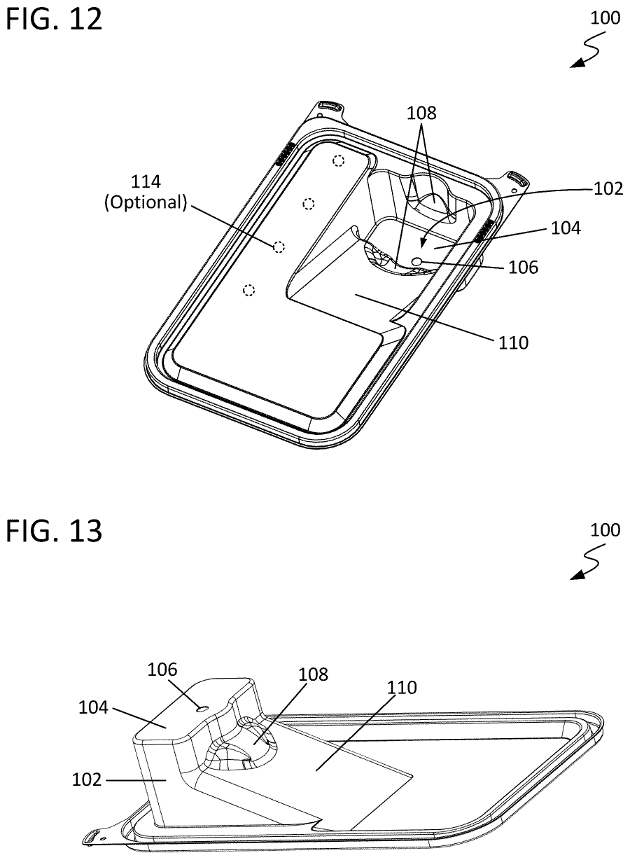

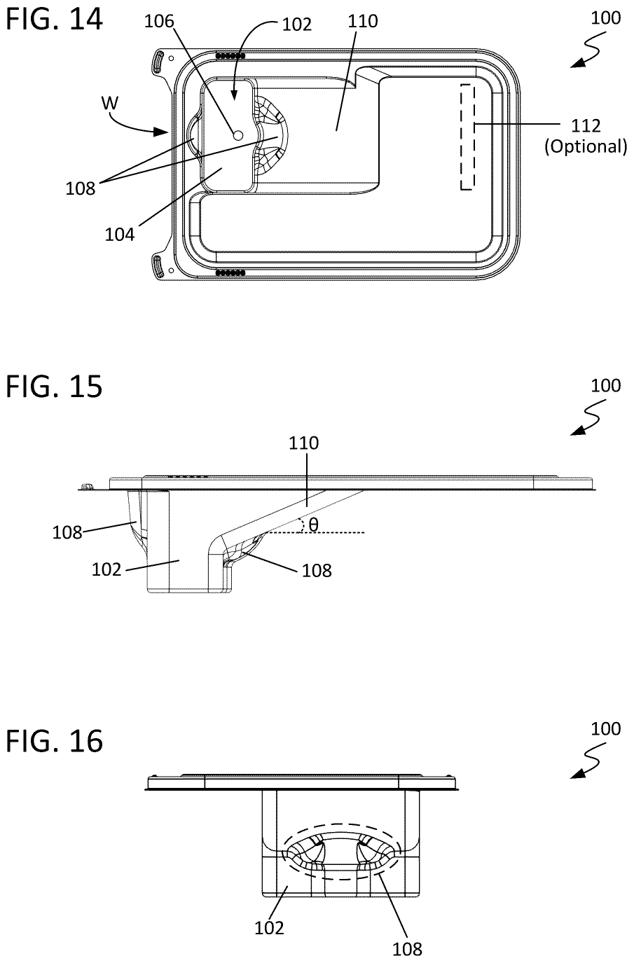

FIGS. 1-11 illustrate several views of a lid 100 configured in accordance with an embodiment of the present disclosure. FIGS. 12-16 illustrate several views of a lid 100 configured in accordance with another embodiment of the present disclosure. As can be seen, lid 100 may include a receptacle feature 102, one or more bottle retention features 108 formed near receptacle feature 102, and a ramp feature 110 adjoining receptacle feature 102. In some embodiments, lid 100 optionally also may include one or more retaining features 112 disposed proximate an end of ramp feature 110. Each of these features is discussed in turn below.

As previously noted, lid 100 may include one or more receptacle features 102. A given receptacle feature 102 may be configured, in accordance with some embodiments, so as to be compatible for use with both (A) a bottle 10 and (B) a soft-bodied container 20. That is, a given receptacle feature 102 may be configured to physically accommodate, at a given time, either a bottle 10 or a soft-bodied container 20, as desired. More specifically, the selected bottle 10 or soft-bodied container 20 in use may be disposed, in part or in whole, within said receptacle feature 102. In this manner, lid 100 may be considered compatible for use with multiple types of liquid sources as opposed to only a single type of liquid source.

In some cases, lid 100 may include only a single receptacle feature 102, whereas in other cases, a plurality of receptacle features 102 (e.g., two, three, four, or more) may be provided. As will be appreciated in light of this disclosure, in cases of a lid 100 being formed with plurality of receptacle features 102, the arrangement of said receptacle features 102 may be customized, as desired for a given target application or end-use. As will be further appreciated, any (or all) of said receptacle features 102 may be adjoined by a corresponding ramp feature 110, as described herein, in accordance with some embodiments.

The dimensions of a given receptacle feature 102 may be customized, as desired for a given target application or end-use. As will be appreciated in light of this disclosure, it may be desirable, at least in some instances, to ensure that a given receptacle feature 102 is of sufficient depth for accommodating a given bottle 10 or soft-bodied container 20 as might be used with lid 100. As will be further so appreciated, it may be desirable, at least in some instances, to ensure that a given receptacle feature 102 is of sufficient dimensions to extend (e.g., descend) into the interior of the main body of an enclosure hosting lid 100 to provide resident animal(s) with access to consume liquid(s) flowing therethrough. The amount of such extension and the particular location of a given receptacle feature 102 with respect to the main body of lid 100 may be customized, as desired for a given target application or end-use. In at least some cases, a given receptacle feature 102 may be of sufficient depth that a bottle 10 inserted therein lies substantially flush with an uppermost surface of lid 100 (e.g., does not extend or otherwise only minimally extends above the general plane of lid 100).

A given receptacle feature 102 may be configured, in a general sense, as a recessed feature (e.g., a well, cavity, basin, depression, or pit) having a substantially empty interior space which is to be occupied, at least in part, by a bottle 10 or soft-bodied container 20 disposed therein. In accordance with some embodiments, a given receptacle feature 102 may have a generally right prismatic geometry; that is, the floor 104 and overlying open end of said receptacle feature 102 may be substantially vertically aligned with one another in footprint, forming a generally box-like shape. Of course, the present disclosure is not intended to be so limited, as other suitable geometries, such as oblique prisms, right cylinders, and oblique cylinders, among others, are envisioned, in accordance with some embodiments.

Also, as can be seen, floor 104 of a given receptacle feature 102 may have one or more orifices 106 formed therein. As will be appreciated in light of this disclosure, the quantity and arrangement, as well as the dimensions and geometry, of any such orifice(s) 106 may be customized, as desired for a given target application or end-use. Through a given orifice 106, liquid may be permitted to flow from a given liquid source (e.g., bottle 10 or soft-bodied container 20) hosted by a given receptacle feature 102 into the interior of an enclosure hosting lid 100. In accordance with some embodiments, a given orifice 106 may be configured for use with a valve 30, which may be received and retained by said orifice 106 and disposed to penetrate (e.g., pierce or puncture) a soft-bodied container 20 seated therein. In some cases, a given orifice 106 may be compatible, for example, with a bottle 10 having a weep hole design, whereby surface tension and suction created from the vacuum in bottle 10 prevents the liquid from dripping constantly, but when an animal touches a suspended droplet of liquid through the weep hole, the surface tension breaks, and the liquid drips out of said orifice 106.

As previously noted, lid 100 may be formed with one or more bottle retention features 108. Generally, any (or all) such bottle retention features 108 may be configured, in accordance with some embodiments, to facilitate retention of a bottle 10 within receptacle feature 102. M ore specifically, bottle retention feature(s) 108 may be formed, in accordance with some embodiments, as one or more grooves, nooks, recesses, shoulders, or other suitable physical features which prevent (or otherwise reduce) movement of bottle 10 within the attendant receptacle feature 102. In a more general sense, bottle retention feature(s) 108 may provide lid 100 with a receiver pocket or region which snugly and securely accommodates a bottle 10 that has been inserted within receptacle feature 102, in accordance with some embodiments. To such ends, the dimensions, geometry, and contours of bottle retention feature(s) 108 may be customized, as desired for a given target application or end-use. For instance, compare FIGS. 1-11, which illustrate an embodiment of lid 100 having a first type of bottle retention features 108, against FIGS. 12-16, which illustrate an embodiment of lid 100 having a different second type of bottle retention features 108. As generally can be seen from the drawings, a given corner of bottle 10 may be seated within a given bottle retention feature 108, thus preventing any significant rotation of said bottle 10 seated within receptacle feature 102.

As previously noted, lid 100 also may include a ramp feature 110 adjoining a given receptacle feature 102. More specifically, ramp feature 110 may adjoin a given receptacle feature 102 such that a bottom of that ramp feature 110 transitions (e.g., directly or indirectly) to the interior of receptacle feature 102. In this manner, ramp feature 110 may be considered to flow downhill into an associated receptacle feature 102.

As can be seen, a given ramp feature 110 may extend (e.g., generally upwardly) away from an associated receptacle feature 102 at an angle (θ), which may be customized, as desired for a given target application or end-use. In some embodiments, the angle may be greater than about 10° (e.g., about 15° or greater, about 20° or greater, about 25° or greater, about 30° or greater, about 35° or greater, about 40° or greater, about 45° or greater, etc.). In some embodiments, the angle may be in the range of about 15-45° (e.g., about 15°-20°, about 20°-25°, about 25°-30°, about 30°-35°, about 35°-40°, about 40°-45°, or any other sub-range in the range of about 15°-45°). In some embodiments, the angle may be in the range of about 30°-50° (e.g., about 30°-35°, about 35°-40°, about 40°-45°, about 45°-50°, or any other sub-range in the range of about 30°-50°). In some embodiments, the angle may be in the range of about 30°±15°, whereas in some other embodiments, the angle may be in the range of about 45°±5°. Other suitable angle ranges for a given ramp feature 110 will depend on a given target application or end-use and will be apparent in light of this disclosure.

The characteristics of the sidewalls defining a given ramp feature 110 may be customized, as desired for a given target application or end-use. In some embodiments, the sidewalls of ramp feature 110 may extend substantially parallel to one another along the length of ramp feature 110. In other embodiments, the sidewalls may converge or diverge at one or more locations along the length of ramp feature 110. In at least some such cases, this tapering or flaring of the shape of ramp feature 110 may provide a funneling effect for said ramp feature 110. As will be appreciated in light of this disclosure, it may be desirable to ensure that the sidewalls of ramp feature 110 are of appropriate configuration for accommodating any of a wide range of soft-bodied containers 20. In some cases, one or more layers of one or more non-slip materials optionally may be disposed over the sidewalls of a given ramp feature 110.

Also, the characteristics of the bottom of ramp feature 110 may be customized, as desired for a given target application or end-use. In some embodiments, the bottom of ramp feature 110 may be, in part or in whole, substantially smooth. In other embodiments, one or more regions of the bottom may be textured (e.g., to facilitate frictional retention of soft-bodied container 20 thereon). In some embodiments, the bottom of ramp feature 110 may be substantially planar (e.g., flat) in contour, whereas in other embodiments, a faceted, articulated, saddle-shaped, or otherwise non-planar contour may be provided. In some embodiments, the bottom of ramp feature 110 may have a substantially linear cross-sectional geometry, whereas in other embodiments, a curvilinear or other non-linear cross-sectional geometry may be provided. Like with the sidewalls discussed above, it may be desirable to ensure that the bottom of ramp feature 110 is of appropriate configuration for accommodating any of a wide range of soft-bodied containers 20. In some cases, one or more layers of one or more non-slip materials optionally may be disposed over the bottom of a given ramp feature 110.

In accordance with some embodiments, lid 100 optionally may include (or otherwise be compatible with hosting) one or more retaining features 112 configured to hold a soft-bodied container 20 in position along ramp feature 110. That is, in accordance with some embodiments, a given retaining feature 112 may be configured to interface, for example, with an end of soft-bodied container 20 that sits distal to receptacle feature 102, thereby fixing said end of soft-bodied container 20 in place (e.g., against the body of lid 100) and preventing soft-bodied container 20 from inadvertently traveling down ramp feature 110 or collapsing in a manner that undesirably traps liquid inside. Some examples of a suitable retaining feature 112 may include a clamp, a clip, a hook, a bracket, a brace, or any other suitable fastening or retention means, as will be apparent in light of this disclosure. In accordance with some embodiments, a given retaining feature 112 optionally may be configured as (or otherwise may include) a feature to pierce or otherwise penetrate soft-bodied container 20. In such cases, one or more filter materials optionally may be employed with a given retaining feature 112, helping to prevent (or otherwise reduce) the opportunity for contamination of soft-bodied container 20 (or, more generally, the animal enclosure hosting such lid 100). For example, in some cases, a woven or nonwoven body of a polyethylene fiber material, such as TYVEK® polyethylene fiber available from DuPont de Nemours, Inc., may be utilized as a suitable filter material for a given retaining feature 112 with piercing or penetrating capability.

In accordance with some embodiments, lid 100 optionally may include one or more ventilation features 114 formed therein. A given ventilation feature 114 may be formed, for example, as an aperture (e.g., a hole, a port, etc.) which extends through the local thickness of lid 100, providing a passageway into and out of the interior of the animal enclosure hosting such lid 100. A given ventilation feature 114 may be configured, in accordance with some embodiments, to allow air or other gas to pass into and/or out of the animal enclosure, providing a given degree of circulation flow. In accordance with some embodiments, such a lid 100 may be used to provide an individually vented cage (IVC)-type of animal enclosure. Furthermore, in accordance with some embodiments, a given ventilation feature 114 optionally further may have one or more filter materials employed thereat, helping to prevent (or otherwise reduce) the opportunity for contamination of the animal enclosure hosting such lid 100. For example, in some cases, a woven or nonwoven body of a polyethylene fiber material, such as TYVEK® polyethylene fiber available from DuPont de Nemours, Inc., may be utilized as a suitable filter material for a given ventilation feature 114. As will be appreciated in light of this disclosure, the quantity and arrangement, as well as the dimensions and geometry, of any such optional ventilation feature(s) 114 may be customized, as desired for a given target application or end-use. In some cases, a plurality of ventilation features 114 may be provided, and the degree of homogeneity or heterogeneity in configuration of such plurality may be customized, as desired for a given target application or end-use.

In addition, the material construction of lid 100 may be customized, as desired for a given target application or end-use. In some cases, lid 100 may be constructed from a single material, whereas in other cases, multiple materials may be utilized. As will be appreciated in light of this disclosure, it may be desirable, at least in some instances, to manufacture lid 100 from one or more materials which are both durable, easily cleanable, and recyclable (at least in part). One example suitable material for use in forming lid 100 is polyethylene terephthalate (PET or PETE). Moreover, the material thickness of lid 100 in a given region thereof may be customized, as desired. Other suitable materials for construction of lid 100 will depend on a given target application or end-use and will be apparent in light of this disclosure.

It further should be noted that lid 100 may be configured, in accordance with some embodiments, to accommodate a given bottle 10 in any of a wide range of orientations. For instance, in some embodiments which include an optional bottle retention feature 108, bottle 10 may be received by lid 100 at an orientation, with respect to an adjacent wall (W), at an angle in the range of about 45° (±10°). That is, in at least some cases, at least one sidewall of bottle 10 may extend in a direction substantially non-parallel to said adjacent wall (W). In some other embodiments which do not include an optional bottle retention feature 108, bottle 10 may be received by lid 100 at an orientation, with respect to an adjacent wall (W), at an angle in the range of about 0° (±10°). That is, in at least some cases, at least one sidewall of bottle 10 may extend in a direction substantially parallel to said adjacent wall (W). In a more general sense, the rotational orientation of bottle 10, when hosted by lid 100, may be customized, as desired for a given target application or end-use. In at least some cases, it may be desirable to orient bottle 10 such that no gap (or an otherwise negligible gap) exists between the structure of bottle 10 and wall (W).

The foregoing description of example embodiments has been presented for the purposes of illustration and description. It is not intended to be exhaustive or to limit the present disclosure to the precise forms disclosed. Many modifications and variations are possible in light of this disclosure. It is intended that the scope of the present disclosure not be limited by this detailed description. Future-filed applications claiming priority to this application may claim the disclosed subject matter in a different manner and generally may include any set of one or more limitations as variously disclosed or otherwise demonstrated herein.

What is claimed is:

1. A lid configured to interface with an animal enclosure, the lid comprising:
a receptacle feature configured to both:
receive, in a first instance, a bottle for supplying liquid to an interior of the animal enclosure; and
receive, in a second instance, a soft-bodied container for supplying liquid to the interior of the animal enclosure; and
a ramp feature adjoining the receptacle feature such that a bottom of the ramp feature transitions to an interior of the receptacle feature, wherein the ramp feature is configured to have at least a portion of the soft-bodied container positioned thereon in the second instance.

2. The lid of claim 1, wherein the bottom of the ramp feature is substantially planar in shape.

3. The lid of claim 1, wherein the bottom of the ramp feature is non-planar in shape.

4. The lid of claim 1, wherein the bottom of the ramp feature is substantially smooth.

5. The lid of claim 1, wherein the bottom of the ramp feature is textured.

6. The lid of claim 1 further comprising a layer of a non-slip material disposed over the bottom of the ramp feature.

7. The lid of claim 1, wherein sidewalls of the ramp feature extend substantially parallel to one another along a length of the ramp feature.

8. The lid of claim 1, wherein sidewalls of the ramp feature converge toward one another along a length of the ramp feature.

9. The lid of claim 1 further comprising a layer of a non-slip material disposed over at least one sidewall of the ramp feature.

10. The lid of claim 1, wherein the ramp feature extends away from the receptacle feature at an angle of about 10° or greater.

11. The lid of claim 1, wherein the ramp feature extends away from the receptacle feature at an angle in the range of about 15-45°.

12. The lid of claim 1, wherein the ramp feature extends away from the receptacle feature at an angle in the range of about 30°-50°.

13. The lid of claim 1, wherein the ramp feature extends away from the receptacle feature at an angle in the range of about 30°±15°.

14. The lid of claim 1, wherein the ramp feature extends away from the receptacle feature at an angle in the range of about 45°±5°.

15. The lid of claim 1, wherein a floor of the receptacle feature has at least one orifice formed therein, through which liquid passes in at least one of the first instance and the second instance.

16. The lid of claim 15, wherein the at least one orifice is configured as a weep hole.

17. The lid of claim 1 further comprising at least one bottle retention feature configured to facilitate retention of the bottle within the receptacle feature in the first instance.

18. The lid of claim 17, wherein the at least one bottle retention feature is configured to prevent rotation of the bottle within the receptacle feature in the first instance.

19. The lid of claim 1 further comprising at least one retaining feature configured to hold the soft-bodied container in position along the ramp feature in the second instance.

20. The lid of claim 19, wherein the at least one retaining feature is configured to interface with an end of the soft-bodied container which is distal to the receptacle feature.

21. The lid of claim 20, wherein in being configured to interface with the end of the soft-bodied container, the at least one retaining feature is configured to clamp the end against a surface of the lid.

22. A system comprising:
the lid of claim 1; and
a valve configured to be disposed at least in part within at least one orifice formed in a floor of the receptacle feature.

23. The system of claim 22, wherein the valve is configured to penetrate the soft-bodied container to allow liquid to flow therefrom through the valve in the second instance.

24. The system of claim 23 further comprising the soft-bodied container.

25. A system comprising:
the lid of claim 1; and
the bottle.
